(19) United States
(12) Patent Application Publication
(10) Pub. No.: US 2006/0096765 A1
(43) Pub. Date: May 11, 2006

(54) Continuously variable multi-surface elephant ear hoe

(76) Inventor: Roger Trozelle, Oakland, OR (US)

Correspondence Address: WILLIAM S. LOVELL, 6435 N. E. NEPTUNE DR., LINCOLN CITY, OR, 97367, US

(21) Appl. No.: 10/972,107

(22) Filed: Oct. 21, 2004

(51) Int. Cl. A01B 1/00

(52) U.S. Cl. 172/371

(57) ABSTRACT

A hoe has a head of a shape in which the radius of curvature of the periphery of that head varies essentially continually throughout the full 360 degrees of that periphery, and has a sharpened edge that likewise extends throughout that full 360 degrees. The head is attached to the handle on the side of the head that is closest to the handle, preferably through a gooseneck connector, so that the 360 degrees of that sharpened edge of the head will have free access to a surface to be worked. All of the various hoeing, chopping, scraping, furrowing and other functions ordinarily carried out with a hoe are thus provided with a working surface on the head, that particularly includes a narrow tip, that can be specifically fit to the task at hand. The connection point between the head and the handle or gooseneck connection if present is placed at the center of mass of the head, so that there will be no tendency for the hoe to rotate around the long axis of the handle after a particular rotational disposition had been chosen.

### CROSS-REFERENCE TO RELATED APPLICATIONS

None

### STATEMENT REGARDING FEDERALLY SPONSORED RESEARCH OR DEVELOPMENT

Not applicable

### REFERENCE TO A SEQUENCE LISTING

Not applicable

### BACKGROUND OF THE INVENTION

1. Field of the Invention

This invention relates to the common garden hoe, and to variations thereof that provide a varying curvature in the shape of the head, and also by attaching the hoe handle at the center of mass of the head so as to eliminate any tendency of the hoe to rotate into a particular orientation.

2. Background Information

After the hand axe and various knives and scraping tools, upon turning from a hunter-gatherer to an agricultural life style, the common garden hoe would very likely have been one of the first implements devised by man. There has thus been a very long history of “prior art.” Of the various kinds of hoes that have been in use over a number of millennia, not very much can be known, but patents do provide some idea of what modifications have been made. The basic hoe has a head for striking the earth, and an elongate handle to which the head is attached, often through a goose-neck type of connection, an example of both of those aspects of the standard garden hoe being given in FIGS. 1-4. The principal variations to that basic design have involved either changes in the shape of the hoe head or the addition of other components to the hoe head, both of which will be addressed herein. However, very little will be described with respect to adding components, since the present invention adds no new components, and what has been attempted in that aspect of the hoe does not pertain to the present invention. This background survey will thus center on attempts to improve the utility of the hoe by making various changes in the shape of the head.

FIG. 1, which is based on the prior art as are FIGS. 2-4, shows in a front elevation view, looking directly at the head, what has been the most common version of the hoe with respect to the head shape, while FIG. 2 shows that head in rear elevation view, looking down the handle. FIGS. 3, 4 then show respective left- and right-side (from the perspective of the user holding the handle) elevation views of the hoe so that the attachment of the hoe head to the handle through the goose-neck connection can better be seen. Because of that goose neck, the center of mass of the hoe head is placed downwardly from the hoe handle so as to place the flat cutting surface of the hoe head farther away from the axis of the handle. By that disposition, upon holding the hoe handle such that the hoe is free to rotate, that flat cutting surface will naturally rotate to the bottom, thus to place that cutting surface the closest to the earth to which it is to be applied. The work of the user is thus made easier for that specific hoeing action only, by the fact that the hoe will automatically rotate into the angular disposition around the handle axis that the user will want when that user starts to apply the hoe to the surface to be worked on. However, any other rotational disposition of the hoe would be attained only by the application of a force by the user.

Hoe 10 can be seen in FIGS. 1-4 to include head 12, handle 14, a tapered, cylindrical handle receiver 16 adapted to receive an end of handle 14 that is likewise so tapered, handle 14 then being affixed within cylindrical handle receiver 16 by rivet 18 or like means as would be known to persons of ordinary skill in the art, and goose neck 20 that is fixed to head 12 by connector 22. Head 12 has a sharpened edge 24 along the one flat side thereof that is intended to contact the ground.

As the various attempts to improve the hoe attest, however, the utility of the common hoe is severely limited, particularly in having but a single flat surface that can be applied to all of the variety of tasks that a user will actually encounter. These various tasks can be seen from the following list of definitions, that will also clarify what is meant when the terms being defined are used elsewhere in this application:
1. Scalping: Removing a thin surface layer of plant growth such as sod so as to expose bare earth;
2. Chopping: Blows with a narrower part of the head so as to remove weeds, severe tree roots, cut runners and the like;
3. Cultivating: Loosening the soil, which will also be a byproduct effect of weeding; and
4. Furrowing: Cutting out a shallow “ditch,” typically V-shaped, for the planting of seeds.

The prior art patents having devices that somewhat resemble the invention are as follows:

U.S. Pat. No. 4,564,072 issued Jan. 14, 1986, to Corbett, describes a garden tool, useful both as a hoe and for edging a lawn, having a head rigidly attached to an elongate handle, that head including a flat blade portion on one side of which there is provided a soil deflection portion. The tool is useable as a hoe in drawing the head through the soil and depositing the removed soil to the side, thus to form a trench, or by rotating to the opposite side of the head, one corner of the head can be used to dig holes for planting. The soil deflecting portion is also useable alone as a hook or scoop to withdraw soil. The device, however, is not of a form by which the action of the head would be continuously variable, so as to fit particular circumstances as is the case with the present invention, and the rigid attachment of the head to the handle will not provide the “bounce” that the invention has by way of its goose neck connection, the latter feature serving to remove the shock to the hands of the user when vigorously applied.

In this Corbett device, however, no means are provided by which the sizes of the ground area to be treated and the precise nature of the task to be carried out can be varied continuously, as is provided by the present invention. The manner of connecting the handle to the head also imparts a bias so that the sharp end of the head will be pointing downward, so the use of the head at other rotational angles, as were noted above, will require the user to oppose the natural rotational torque imparted to the head by gravity, whereas the present invention is made to be rotationally neutral in placing the axis of the handle so as to pass through the center of mass of the head.

U.S. Pat. No. 5,628,370 issued May 13, 1997, to Chrysler has a heart-shaped head that can be applied to the ground in different rotational orientations for different purposes, including edging, weeding, cutting, the pulling of weeds, and removing ice from walks and drives. Heads having 4″, 6″, and 7″ sizes can be attached to the hoe handle so as to carry out tasks that differ in the sizes of the ground regions that are to be addressed. With respect to the different tasks to be performed, in discrete types of operation the pointed end of the heart shape goes through the ground easier than do the other parts, is useful for making furrows, and is also applicable to the digging of holes of the size of the hoe head, the side surface that has a larger arc can be used for hoeing and the removal of ice, and the opposite “V” shape can serve as a weed puller.

U.S. Pat. No. 4,865,133 issued to Dawley et al. on Sep. 12, 1989, describes a hoe having a “V” shape on the sharp cutting edge thereof that extends part way to the opposite side thereof, thus to yield five sides, wherein each edge of the “V” parts has approximately three concave arcuate notches therealong. Those sharp edges are intended to serve for furrowing, and to do weeding without having to swing the hoe, specifically by sliding the head back and forth at or slightly below ground level.

U.S. Pat. No. 4,890,679 issued to Jacobs on Jan. 2, 1990, describes a one-piece tool in which the normal hoe head has been altered by the provision on each side thereof of an angled slot, to serve both as a scythe and whereby the placement of a slot around the root of a fibrous weed and then prying permits that weed to be lifted out of the ground, or similarly the limbs of bushes may be clipped.

U.S. Pat. No. 5,477,929 issued Dec. 26, 1995, to Kenyon, et al., describes a hoe having a trapezoidal head, the apex of which serves as the working surface, connected at the base side thereof to the handle by a rigid, L-shaped connector. The invention is directed towards having a metal handle that has a spacer that will break any electrical connection between the handle and the head.

U.S. Pat. No. 6,533,043 issued Mar. 18, 2003, to Duyck, et al., describes a vertical hoe in which the head is rigidly attached to the handle and has a single, flat, outwardly flared working surface, intended specifically for the particular task of removing unwanted plants.

U.S. Pat. No. 4,432,421 issued Feb. 21, 1984, to Granberg, describes a hoe having a number of flanged, parallel “earth working elements” that extend out in both directions from the handle, having cutting surfaces at both distal ends of those blades, comprising a tined side and a cutting edge, which elements are partially rotatable. These elements generally address the ground at an oblique angle, and the small rotation that those elements execute provides both a self-cleaning and a self-sharpening feature when extended forwardly, opposite to the movement of being drawn towards the user for cutting and similar purposes.

U.S. Pat. No. 6,044,914 issued Apr. 4, 2000, to Johnson, describes a garden tool adapted particularly to the relief of back pain deriving from the removal of plants. The tool head is in the general shape of an open ended rectangular box, also open at the top, that is rigidly attached to an elongate handle having an arcuate “T” shape at the opposite end thereof. The leading, blade-like part of the head is pushed forward so as to cut off the plant roots, but is limited to that kind of use. The sides of the “box” serve as “fins” to stabilize the blade during the forward movement of the blade.

A modified version of the aforesaid Johnson device appeared as U.S. Pat. No. 6,446,733, issued to Johnson on Sep. 10, 2002, now further including the inclusion in the handle of an adjustment permitting the length of the handle to be varied.

U.S. Pat. No. 6,179,062 issued Jan. 30, 2001, to Firman, describes a garden tool having a head that in cross-section is a sharply turned C-shape, turning a full 180° and having a flat bottom surface. The head, which is rigidly attached at an angle to an elongate handle, when viewed face-on is further seen to comprise a set of three of arms that will engage the soil when pushed forward, there also being a wire drawn from a spindle and then disposed laterally between the two outer arms, thus being across the direction of motion, that will severe the roots of weeds when the device is force through the soil. A turnbuckle serves to adjust the tension in the wire.

Adjustment means are also provided in the Firman device whereby the head can be There is, however, no means by which sizes of the ground area to be treated and the precise nature of the task to be carried out can be varied continuously, as is provided by the present invention. The manner of connecting the handle to the head also imparts a bias so that the sharp end of the head will naturally be pointing downward, so the use of the head at other rotational angles, as were noted above will require the user to oppose that natural rotational torque imparted to the head by gravity, whereas the invention is rotationally neutral in placing the axis of the handle so as to pass through the center of mass of the head.

U.S. Pat. No. 5,529,129 issued Jun. 25, 1996, to Byrd, describes a hoe head, adapted for use principally as a trenching too, in the form of a hollow tube that can be either circular or square in cross-section, with the end towards the user being slanted back towards the handle so as to provide an appropriate cutting angle, with the region within the tube serving to collect and carry away the dirt removed in making a furrow.

U.S. Pat. No. 5,560,434 issued Oct. 1, 1996, to Janik, describes a hoe head having serrated edges for more effective sawing and being shaped in a four-pointed “star” configuration, the points of which are triangular, tapering down to a blunt, flattened “point” at the ends, but also including circular and square shapes. These shapes permit the head to be applied laterally, or indeed substantially around 360 degrees, as well as in the usual straight-line manner.

U.S. Pat. No. 5,549,167 issued Aug. 27, 1996 to Keperling, Sr., et al, sets out a “hill making hoe” having semicircularly rearwardly opposing concavo-convex blades, such shape being adapted to the formation of hills for the planting of vine plants in a garden.

U.S. Pat. No. 3,965,990 issued Jun. 29, 1976, to Pittman, describes a hoe having “working body portion,” a tapered digging blade, and a pair of elongated rake blades as discrete elements that are selected for use, without having the type of continuous variation in the working surface as is provided by the invention.

U.S. Pat. No. 5,285,855 issued to Bojar on Feb. 15, 1994, describes a tool having an adjustable pitch head by which the pitch or “bite” (cutting angle) can be adjusted for different purposes. An elongate, U-shaped structure that is spring loaded and mounted to the handle at a pivot point serves as the head.

U.S. Pat. No. 4,093,031 issued to Portz on Jun. 6, 1978, describes a hoe having as the head thereof a rotatable, pendulum-like structure in the form of a stirrup-like, U-shaped blade, wherein the sharpened lower portion of the blade is used to contact the ground. The principle by which the Portz device operates is thus quite distinct from the present invention.

As just one example of the need for the present invention, in the Sep. 24, 2004, issue of the Eugene Register Guard, Eugene, Oreg., p. A5, it was reported that the California Occupational Safety and Health Division has banned weeding by hand on most farms because of the substantial back injuries suffered by field workers due to repeated bending over. Those farm workers must now be provided with a long handled hoe, but since weeding is a delicate task wherein the weed must be removed but the crop plant left uninjured, particularly as to lettuce, carrots, strawberries and celery, the tool used must be able to be placed quite precisely, with the cutting surface preferably being of a size, curvature and orientation that will carefully separate crop plant and weed in making each cut. Of the various hoes described herein, and of all others of which the inventor is aware, only the hoe head of the present invention provides to the user the ability to make those kinds of fine adjustment.

In summary, it is concluded by this inventor that none of the aforesaid patents either anticipate or suggest the principle aspects of the present invention, which will now be summarized and then shown and described in detail.

### SUMMARY OF THE INVENTION

The invention comprises a modified hoe principally including a unique head, mounted to an elongate handle through a gooseneck, whereby the hoe head can be applied to the ground at any rotational angle, with the curvature of the striking surface of the hoe head varying continuously around those 360 degrees, thus to allow the user to adjust the nature of the surface then to be used to match up with the nature of the task then to be carried out.

### BRIEF DESCRIPTION OF THE SEVERAL VIEWS OF THE DRAWINGS

A preferred embodiment of the invention, intended only to provide an example of preferred embodiments of the invention and not to be limiting in any way, will now be described with reference to the drawings, in which:

FIG. 1 is a front elevation view taken from the prior art of the head of a common garden hoe.

FIG. 2 is a rear elevation view of the hoe head of FIG. 1.

FIG. 3 is a left side elevation view as seen by the user taken from the prior art of an entire common garden hoe as was shown partially in FIGS. 1, 2.

FIG. 4 is a right side elevation view of the entire hoe of FIG. 3.

FIG. 5 is a front elevation view of the head of a first preferred embodiment of the invention.

FIG. 6 is a rear elevation view of the hoe head of FIG. 5.

FIG. 7 is a left side elevation view as seen by the user of an entire first preferred embodiment of the invention as was shown partially in FIGS. 5, 6.

FIG. 8 is a right side elevation view of the hoe of FIG. 7.

FIG. 9 is a front elevation view of the head of a second preferred embodiment of the invention.

FIG. 10 is a rear elevation view of the hoe head of FIG. 9.

FIG. 11 is a left side elevation view as seen by the user of an entire second preferred embodiment of the invention as was shown partially in FIGS. 9, 10.

FIG. 12 is a right side elevation view as seen by the user of an entire second preferred embodiment of the invention as was shown partially in FIGS. 9, 10.

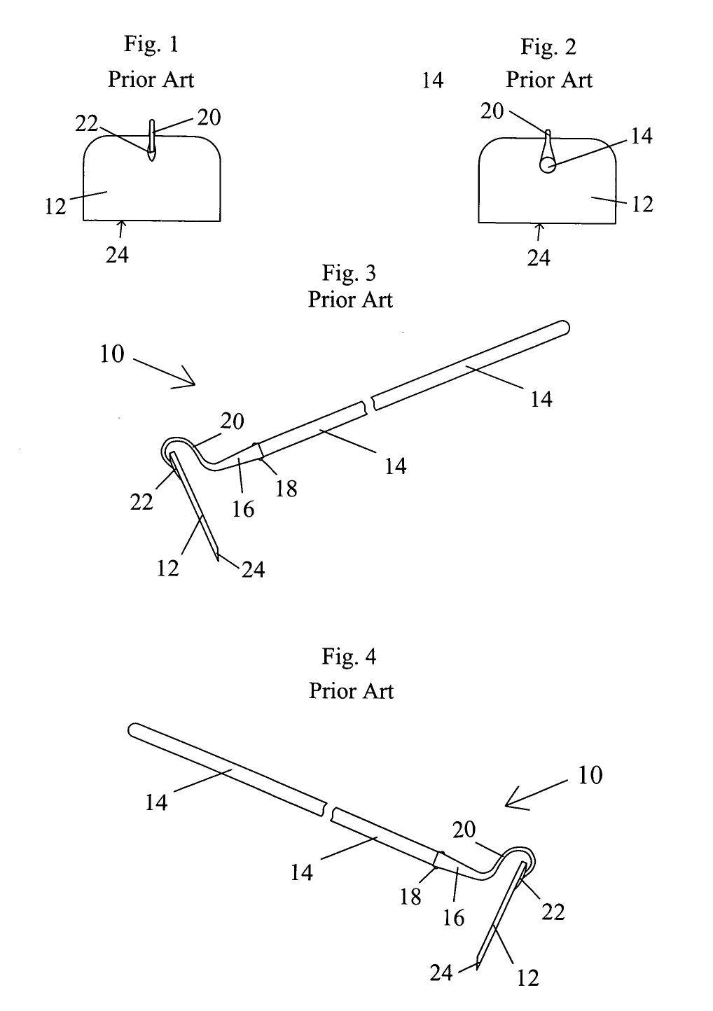

### DETAILED DESCRIPTION OF THE INVENTION

In general, the prior art exhibits an effort to enlarge the utility of the ordinary hoe, in many cases by providing additional components (many of which are not further referenced herein), but in many others simply by changing the shape or structure of a single “head” element. The invention seeks to enlarge the utility of the hoe with the same motivation as underlaid the prior art patents cited, but is to be distinguished from that prior art by the invention having used significantly different means to do so, which means expand the utility of the hoe more completely in a different way, more easily, and provide to the user more convenience that also requires much less expenditure of effort. That is done not by providing some single variation in the shape of the single head, or by adding more parts, but principally by means of a head shape that has a continuously variable working surface, the actual contact surface that will actually encounter the ground being easily selectable merely by rotating the hoe about the long axis of the handle. The user, in a sense, thus has many tools in one, any one of which can be adopted for use at the moment by a simple turn of the hands.

The hoe handle is connected to the hoe head by a gooseneck connection in such a way that the long axis of the handle will pass through the center of mass of the hoe head. As a result, there will be no torque developed by the weight of the hoe head that the user would have to overcome in order to attain and then maintain a desired rotational disposition. The hoe head will automatically assume and retain whatever rotational disposition that the user might wish to impart, or one that the hoe might have had when first picked up, but without the user having to oppose by force any torque that would tend to place that rotational disposition otherwise.

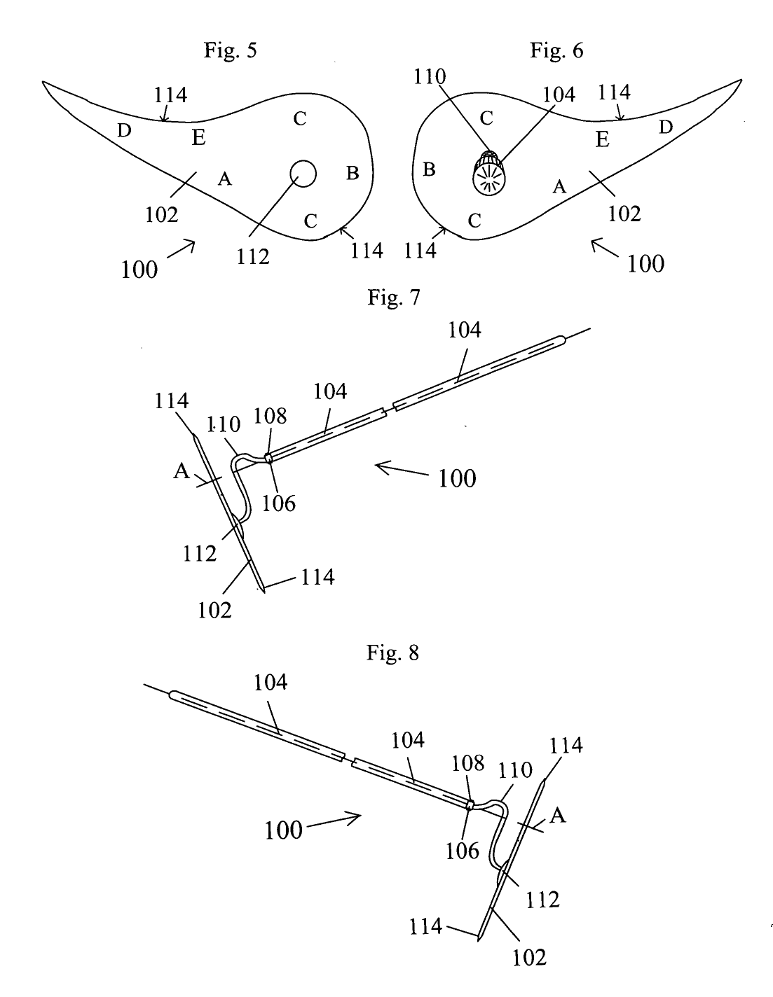

In FIGS. 5-8, hoe 100 is seen to include a hoe head 102 that is disc-like in structure, having a rather convoluted shape bearing a sharp knife edge 114 all around the periphery thereof. The gross construction of hoe 100 is similar to that of the prior art hoe, and includes a head 102, the handle 104, the handle receiver 106 into which the proximal end of handle 104 is inserted, and rivets 108 are used as before to attach handle 104 onto handle receiver 106. A gooseneck 110 connects between handle receiver 106 and head 102, and is attached thereto by connector 112. Unlike the prior art hoe 10, however, in hoe 100 that constitutes the invention, gooseneck 110 connects to the side of head 102 that is near to the user rather than looping over the top of the head to connect on the far side.

Some particular aspects of the aforesaid parts should be noted. Handle 104 will typically and preferably be of wood, usually ash or hickory. However, handle 110 can be of plastic for less weight, or of any other such material as will withstand the load and flexing that will be applied thereto and have sufficient life. Gooseneck 110 will preferably have a thickness that is small enough to provide the degree of “spring” desired, but not so small as to be susceptible to metal fatigue after an extended period of use. Head 102 can be of steel, of Dura-ware® (Trademark of DURA-WARE CO. OF AMERICA INC.), or any similar such material as will accept and hold a sharp edge under the often rigorous conditions encountered in garden work, as in the chopping through of roots and the like.

Selected parts of the edge of head 102 have been designed for specific tasks, and since the tasks to be carried out using the hoe are so variable, as are the conditions of the soil on which the hoe would be used, so has the head shape been structured in order to provide a working surface that is likewise continuously variable. An opportunity for precision in placement, and in the exact size of the head surface that will contact the ground area at a particular moment, are thus provided. This structure will allow, as an example, the carrying out of weeding with an accuracy that is comparable to that from hand weeding but with much less effort and strain on the user, as well as allowing the user to carry out a number of other tasks for which the ordinary hoe is ill-suited. It should be understood that the precise shape of head 102 in FIGS. 5, 6 is representative only, so as to demonstrate the manner in which a wide range of head widths that could be applied to the ground is made available by the invention, and hence the interpretation of the claims hereinafter should not be limited to the one exact shape shown, but also to such variations thereof that would be obvious to a person of ordinary skill in the art.

An aspect of the apparatus comprising the invention that is disclosed in the prior art is the use of a gooseneck connection to the hoe head, and that feature is also exhibited in the invention as shown by gooseneck 110 of FIGS. 7, 8. Head 102 of the invention, however, has quite a unique shape, but so as to relate that feature generally to the prior art, it might first be noted that the tasks that can be carried out by the invention as a result of that feature at least include (1) scalping; (2) chopping; (3) hoeing; (4) furrowing; (5) cultivating; (6) mounding; and (7) continuously variable combinations of those tasks in order to meet the continuously variable circumstances under which hoe 100 is used.

Hoe 100 also provides certain ergonomic advantages in its improved ease of use, in that the careful placement of the point of connection between head 102 and gooseneck 110 acts to render the rotational disposition of hoe 100 completely neutral: regardless of what the orientation of head 102 might be relative to the ground when hoe 100 is picked up, there will be no tendency for hoe 100 to rotate from that orientation to a different orientation. Of course, that also means that if the user places the hoe in a rotational orientation that is best adapted to the particular task then being carried out, no effort is required to maintain hoe 100 in that rotational orientation. The amount of torque generated by the prior art hoe 10 is of course not very large, but nevertheless could be a source of constant, low-level strain on the hands, wrists and arms of the user if the hoe were to be used in any rotational disposition other than with the cutting edge parallel to the ground. Hoe 100 according to the invention generates no such torque, regardless of what rotational orientation is given initially to the hoe, but yet it is quite easy for the user to rotate hoe 100 to any orientation desired by a simple rotation around handle 104 axis.

Connector 112 would usually be made by a weld, but there again that connection might be made by other means, especially as to be removable, by using a bolt wherein the handle receiver would be internally threaded so as to receive such a bolt through a hole in head 102 that was properly positioned at the center of mass of head 102. A severely damaged head 102 could then be easily replaced.

Since the kinds of tasks to which hoe 100 might be applied range continuously from needing to cut out a narrow furrow with the narrowest part of head 102 to scalping off plant growth on the ground surface using the widest part of head 102, the description of how the different parts of head 102 can likewise be applied to carry out those tasks will vary continuously in the same way, with there being no discrete positions in which head 102 is specifically adapted to carry out a particular task, and no other. Because of that, although FIGS. 5, 6 have had separate regions A-E marked thereon, it should be understood that no such region is discretely and uniquely fit for the particular task, but is simply a region that can be reasonably identified as being adapted to the particular task, the specific nature of which will vary with the circumstances.

The following list identifies in general terms a specific one of the several tasks to which hoe 100 can be applied that can best be carried out by each of regions A-E:
A: Scalping
B: Chopping
C: Hoeing
D: Furrowing/cultivating
E. Mounding.
   The scalping function will require the most power, and could best be carried out by having the widest surface to be applied to the ground, i.e., region A, but alternated with a smaller surface and more concentrated power when tougher, more compact ground is encountered. Chopping, which does not require as much power but should still encompass a wide region, is best be carried out by using region B. That long edge of region B also serves well on shallow rooted weeds such as chickweed that cover a large area. Hoeing, which must be carefully controlled so as to adjust to the manner in which weeds may be disposed near to or even entangled with the desired plants, might be carried out by using a range of widths, and for that reason two regions C are shown in FIGS. 5, 6 for that purpose. However, and particularly in this case, hoeing might under various circumstances be carried out best at just about any rotational disposition of head 102. In particular, using the narrowest region D would facilitate the removal of a long dandelion or thistle root. Cutting furrows would also usually best carried be out by the narrowest region D of head 102, but there again the particular width of the head 102 surface that is actually used can be varied to encompass a range of furrow widths as may be desired, as well as variations in how compact or loose the soil may be. The cultivation of a ground region to prepare it for planting might also be carried out by applying region D repeatedly to the ground area in question, again varying the surface width as the soil conditions may dictate. Finally, the concave portion of head 102 that makes up region E can be used in planting, where a furrow has been cut, seeds have been planted, and then the dirt is filled back in. Region E can then be drawn along the length of the row to form a mound of dirt above the furrow and planted seeds.

In any case, it is evident that none of the patents that the Applicant has found and that are described herein either shows or suggests the principal feature of the invention, which is that hoe 100 provides a wide range of different functions, amounting almost to having a whole set of tools rather than just the one, that can be carried out by the single tool of hoe 100. For example, although the Chrysler '370 patent describes a hoe having a head with a heart shape in which the radius of curvature must obviously vary, that variation is in a quite regular way so as to imitate a “Valentine-type” heart (evidently for aesthetic reasons), but the variation is not claimed nor seen to serve any functional purpose except that the point of the “heart” can serve the single purpose of cutting a furrow. (Also, the inwardly curved part of the head can be used for catching onto materials so as to pull them, but not in any special way to apply the edge of the hoe to any chopping or similar function.)

In order to take advantage of the shape of head 102, the radius of curvature of which varies continuously throughout the full 360 degrees of rotational freedom of head 102, one must obviously be able to apply the sharpened edge of head 102 to the ground all the way around those 360 degrees. That is only made possible if the connection between head 102 and handle 104 is placed on the side of hoe 100 that is towards the user, rather than looping over to the opposite side, away from the user, as is seen in several of the prior art hoes noted above and in FIGS. 3, 4. It is clear from FIG. 7 that if hoe 100 were to be rotated in a full circle around axis A, shown by the dashed line that runs the full length of handle 104 and on past head 102, edges 114 could still have direct contact with the ground, while if prior art hoe 10 were rotated around a similar axis by 180 degrees, head 12 could not touch the ground since gooseneck 20 would be in the way. Although the precise shape of head 102 may vary slightly, FIGS. 5, 6 do show the basic principle of this aspect of the invention, and those figures can show only one particular, exemplar instance of the wide range of exact shapes that could be used while still maintaining the principle that the curvature is to vary substantially, thus to provide a very wide range of possible edge shapes within the single tool.

There are different methods by which the location of the center of mass of head 102 can be found. A quick and practical way would be to place head 102, that has not yet had any work done with it except as to sharpening edge 114, flat on top of a sharply pointed, vertical nail or the like, and then adjust the point of contact of the underside of head 102 with the point of the nail until head 102 acquired a perfectly flat disposition. The force of gravity in every direction around that point of contact would then be the same for this purpose, meaning that such point of contact would be the center of mass. A sharp blow on the upper side of head 102 would then mark that point of contact on the lower side of head 102, and the further construction as to the placement of gooseneck 110 so as to be centered on the mark so made could then be carried out.

Another method that is indirect but would be more scientific and accurate rests on the assumption that a template of some sort would have been drawn that might have been used, in fact, to lay on a sheet of metal so as to cut out the actual head 102 in the desired shape. In that case, there are a number of different types of software of the Computer Aided Design (CAD) variety, such as the MATLAB program provided by Mathworks, Inc., that if such a drawing were entered therein, would calculate and mark in the precise center of mass of the body as a whole. A print of that drawing with the center of mass marked thereon could then be placed on the sheet of metal, and the center of mass could be marked onto that metal from the print. Another advantage of using this method, although one that would not be too essential in an item such as a hoe, is that in drawing the shape, the actual radius of curvature at any point along the line can be displayed, and the position of the line as that line was being drawn could be adjusted so as more accurately to yield a radius of curvature that would vary linearly along certain portions of the curve, thus to yield a shape that would encompass more truly every degree of curvature accessible, in a smooth and even way.

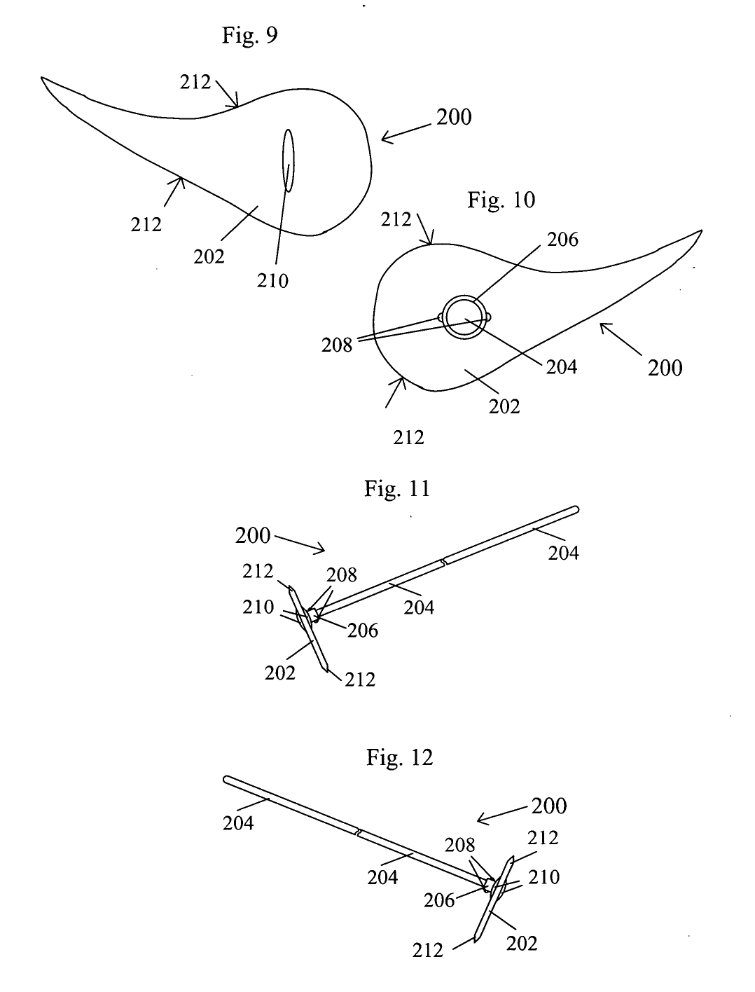

For purposes of completeness, another embodiment of the invention that would provide both the 360 degree access to the head edge and the rotational balance of the hoe as a whole, as described earlier with respect to hoe 100, is shown in hoe 200 of FIGS. 9-12. Hoe 200 is essentially a duplicate of hoe 100 of FIGS. 5-8 except that the connection of the handle of the hoe to the head is made directly, without an intervening gooseneck. In FIGS. 9-12 the several parts of hoe 200 are: head 202, handle 204, handle receiver 206, rivets 208, connector 210, and edge 212, where again the precise manner of the connection between handle 204 and handle receiver 206 may be of any of a number of different ways as will be known to a person of ordinary skill in the art. Connector 210 would usually be made by a weld, but there again that connection might be made by other means, especially as to be removable, by using a bolt wherein the handle receiver would be internally threaded so as to receive such a bolt through a hole in head 202 that was properly positioned at the center of mass of head 202. A severely damaged head 202 could then be easily replaced.

The specific apparatus and procedures as set forth above are of course exemplary only and not limiting, and as has been indicated, a specific embodiment of the invention, or of such variations therefrom especially as to the exact radii of curvature and materials that were used as would be obvious to a person of ordinary skill in the art, must be taken also to be encompassed by the invention, which is to be interpreted and construed only in light of the following claims.

1. A hoe comprising:
an elongate handle; and
a planar head having a sharpened edge around the full periphery thereof, and being attached at a connection point to a distal end of said handle, wherein said head has a varying radius of curvature around that full periphery of said head;

2. The hoe of claim 1 wherein said connection point is disposed within said head at a position within a lateral cross-section of said head as constitutes the center of mass of said head;

3. The hoe of claim 1 wherein said connection point lies on that side of said head that faces said handle;

4. The hoe of claim 2 wherein said connection point lies on that side of said head that faces said handle;

5. The hoe of claim 1 wherein a gooseneck connector is interposed between said handle and said head;

6. The hoe of claim 2 wherein a gooseneck connector is interposed between said handle and said head; and

7. The hoe of claim 3 wherein a gooseneck connector is interposed between said handle and said head.

8. The hoe of claim 4 wherein a gooseneck connector is interposed between said handle and said head.
